(19) United States
(12) Patent Application Publication
(10) Pub. No.: US 2015/0261830 A1
(43) Pub. Date: Sep. 17, 2015

(54) AUTOMATED DATA MINING

(71) Applicant: Adrian Capdefier, St. Albans (GB)

(72) Inventor: Adrian Capdefier, St. Albans (GB)

(21) Appl. No.: 14/643,950

(22) Filed: Mar. 10, 2015

Related U.S. Application Data
(60) Provisional application No. 61/951,398, filed on Mar. 11, 2014.

(51) Int. Cl. G06F 17/30

(52) U.S. Cl. CPC G06F 17/30539; G06F 17/30551

(57) ABSTRACT

A computer program product to determine correlations between seemingly independent datasets including operations of receiving an indication of one or more reference files, receiving an indication of one or more connections between the one or more reference files and individual ones of one or more fact attributes of a fact file, modifying, in response to identifying the first connection, the fact file to include the one or more reference values associated with the first reference attribute to create an enriched fact file. Time-specific fact files may be generated corresponding to each permutation of a single fact attribute and a single time value in the enriched fact file. Correlations may be determined between individual fact values of a previous time series generated from the time-specific fact files and individual fact values of the generated time series based on the determined lag times.

### CROSS-REFERENCE TO RELATED APPLICATIONS

The current application is related to/claims priority under 35 U.S.C. §119(e) to U.S. Provisional Patent Application No. 61/951,398 filed on Mar. 11, 2014, which is herein incorporated by reference.

### TECHNICAL FIELD

The subject matter described herein relates to automated data mining, and more specifically to identifying correlations between seemingly independent data sets using massively parallel computing technologies and distance correlation.

### BACKGROUND

Big data generally refers to a large collection of data that comes from structured, unstructured and semi-structured data sources. Many entities collect, store, manipulate and manage this data. Attempts to correlate the different datasets have been made. These attempts typically require manually identifying the connections between the datasets.

While there is an urge to gather vast amounts of data, the true value of the data will be realized only when it can be analyzed and useful information determined from it. Improving the accuracy of the analysis may involve aggregating datasets. Determining correlations between seemingly disparate datasets will allow greater aggregation and may improve accuracy of any analysis.

### SUMMARY

In one aspect of the current subject matter a computer program product configured to determine correlations between seemingly independent datasets is disclosed. A computer program product may comprise a non-transitory machine-readable medium storing instructions that, when executed by at least one programmable processor, cause the at least one programmable processor to perform a number of operations.

An indication of one or more reference files may be received. The one or more reference files may include one or more reference attributes. The one or more reference files may include one or more values associated with individual ones of the reference attributes. The one or more reference files may include one or more connections between other reference files of the one or more reference files.

An indication of one or more connections may be received. The one or more connections may be between the one or more reference files and individual ones of one or more fact attributes of a fact file. The fact file may include one or more fact attributes. The fact attributes may have one or more fact values associated with the fact attributes. The one or more fact files may include one or more time values associated with one or more fact attributes.

For individual ones of the one or more fact attributes, a connection may be identified. The connection identified may be between an individual one of the one or more fact attributes and individual ones of the one or more reference attributes. For example, a first connection may be identified between a first fact attribute and a first reference attribute.

In response to identifying the first connection, the fact file may be modified. The fact file may be modified to include the one or more reference values associated with the first reference attribute to create an enriched fact file.

In some variations one or more of the following features can optionally be included in any feasible combination. Responsive to modifying the fact file, for individual ones of the one or more fact attributes, a second connection may be identified between the first fact attribute and a second reference attribute. In response to identifying the second connection, the fact file may be modified to include the one or more reference values associated with the second reference attribute.

Time-specific fact files may be generated corresponding to each permutation of a single fact attribute and a single time value in the enriched fact file. Individual ones of the time-specific fact files may include a fact attribute and associated fact value and a time value corresponding to the fact attribute.

Individual time-specific fact files may be identified that include time values associated with individual time increments. A time series may be generated by associating fact attributes in the individual time-specific fact files with individual ones of the time increments. The time series may be generated based on the identified time values associated with the individual time increments.

Constraints for correlating the generated time series with previous time series may be received. The constraints may include limits on one or more parameters of previous time series. The constraints may dictate which of the previous time series can be used for determining correlations between fact values in the generated time series and fact values in previous time series.

A previous time series may be received. The previous time series may have fact values falling within one or more limits of the constraints. Lag times may be determined between individual attributes of the previous time series and individual attributes of the generated time series. A correlation may be determined between individual fact values of the previous time series and individual fact values of the generated time series based on the determined lag times.

In some variations, the one or more parameters of the previous time series may include an age of the fact values. The constraints for correlating the generated time series with previous time series may include a maximum age. The one or more parameters of the previous time series may include an amount of fact values corresponding to individual time increments. The constraints for correlating the generated time series with previous time series may include a minimum amount of fact values associated with individual time increments.

The one or more parameters of the previous time series may include a lag amount between previous correlations. The constraints for correlating the generated time series with previous time series may include a maximum lag amount.

Time-specific attribute-specific fact files may be generated. The time-specific, attribute-specific fact files may correspond to each permutation of a single fact attribute, a single time value, and a single reference attribute in the enriched fact file.

Value-specific fact files may be generated. The value-specific fact files may correspond to each permutation of fact and time pairs of the enriched fact file and individual reference value of the reference values in at least one of the reference attributes.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

Implementations of the current subject matter can provide one or more advantages. For example, the presently disclosed subject matter can identify correlations between seemingly independent data sets. The presently disclosed subject matter may be used by persons who are non-expert users of the datasets to determine these correlations. The presently disclosed subject matter may determine these correlations in an automated manner. The presently disclosed subject matter can identify amounts that are correlated between themselves. The presently disclosed subject matter can also identify all subsets of attributes where the correlation is valid and whether any lag is present.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a business software solution, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows an exemplary illustration of a cause and effect timeline;

FIG. 2 shows a process flow diagram illustrating aspects of a method having one or more features consistent with implementations of the current subject matter;

FIG. 3 shows two conceptual illustrations of datasets, having one or more features consistent with implementations of the current subject matter;

FIG. 4 shows a conceptual illustration of a file registry, having one or more features consistent with implementations of the current subject matter;

FIG. 5 shows a conceptual illustration the contents of the first dataset and the second dataset, as shown in FIG. 3, as loaded into a file registry by a process, having one or more features consistent with implementations of the current subject matter;

FIG. 6 shows a conceptual illustration of a fact file being amended by the process illustrated in FIG. 2, having one or more features consistent with implementations of the current subject matter;

FIG. 7 shows a conceptual illustration of enriched fact files, having one or more features consistent with implementations of the current subject matter;

FIG. 8 shows a conceptual illustration of enriched fact files having no identity columns, having one or more features consistent with implementations of the current subject matter;

FIG. 9 shows a process flow diagram illustrating aspects of a method having one or more features consistent with implementations of the current subject matter;

FIG. 10 shows a conceptual illustration of each of the fact files of FIG. 7 split into each permutation of one fact and one time value, processed by a method having one or more features consistent with implementations of the current subject matter;

FIG. 11 shows a conceptual illustration of the time-specific fact file of the second dataset as shown in FIG. 10 having been split for each pair of one fact and one time value and all possible combinations for the set of attribute columns in that file, the fact file having been processed by a method having one or more features consistent with implementations of the current subject matter;

FIG. 12 shows a conceptual illustration of two time-specific attribute-specific fact files of FIG. 11 split for every permutation of value in each of the attribute columns, having been processed by a method having one or more features consistent with implementations of the current subject matter;

FIG. 13 shows a conceptual illustration of a time value of one of the files conceptually illustrated in FIG. 12 expanded to each level across a time hierarchy;

FIG. 14 shows a table conceptually illustrating the number of files, or segments, created when a process, having one or more features consistent with implementations of the current subject matter, is applied to the three enriched fact files conceptually illustrated in FIG. 10;

FIG. 15 conceptually illustrates a list of values after aggregation of the time values created using a process having one or more features consistent with implementations of the current subject matter, in a specific example of a travel ledger;

FIG. 16 conceptually illustrates a sparse matrix in a large column database, into which, the segments, or files, resulting from the Time Series conceptually illustrated in FIG. 15 is written during a process having one or more features consistent with implementations of the current subject matter; and,

FIG. 17 shows a table conceptually illustrating exploitation of distance correlations calculated during a process having one or more features consistent with implementations of the current subject matter.

When practical, similar reference numbers denote similar structures, features, or elements.

### DETAILED DESCRIPTION

Various implementations of the current subject matter relate to methods, systems, and/or computer program products that involve identification of correlations between disparate datasets. Society as whole, individuals, governments, business entities, etc. reacts to events, and these reactions are generally governed by an underlying cause and effect principle. In many cases, there may be a single cause with multiple effects. In some circumstances, the underlying cause for observed effects is unknown. However, by observing the effects and correlating those effects with previous observations, it may be possible to determine knock-on effects and plan accordingly. The presently disclosed subject matter addresses a way to correlate between measured effects and previously observed and seemingly independent effects, to determine correlations. These determined correlations can be used to predict future events which will, among other potential advantages, allow more effective predictions and planning.

Effects may be measured and/or observed by any entity. Some such observing entities may include, without limitation, the public, governments and/or companies. Effects can include, without limitation, changes to the Consumer Price Index, Total Spend with Merchants, stock prices, number of transactions, number of orders, and/or other effects.

Seemingly independent effects may occur at different points in time. However, the presently disclosed subject matter provides a solution such that the effects may be correlated and a common cause and/or common result may be identified.

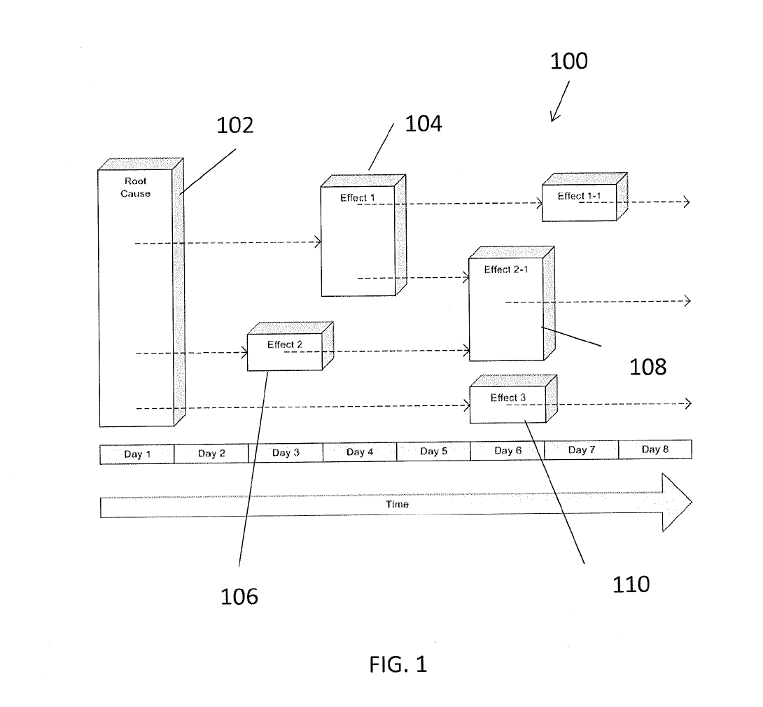

FIG. 1 illustrates an example cause and effect timeline 100. The timeline 100 includes a root cause 102 and multiple effects stemming from the root cause 102. The root cause 102 may be unobserved. Effect 1 104 and effect 2 106 may occur at various times after the root cause 102. Effect 2-1 108 may occur at some time after effect 1 104 and effect 2 106. Effect 2-1 108 may be correlated with effect 1 104 and effect 2 106. Effects similar to effect 2-1 108, effect 2 106 and effect 1 104 may have occurred in the past. Effects similar to effect 2-1 108 may have occurred after certain time periods after effects similar to effect 1 104 and effect 2 106. Consequently, it may be possible to predict the occurrence of effect 2-1 108 after the occurrence of effect 1 104 and/or effect 2 106.

Effect 3 110, seemingly independent from effect 1 104 and effect 2 106, may occur at a time after effect 1 104 and effect 2 106. The presently disclosed subject matter may facilitate prediction of future effects based on observed effects. The presently disclosed subject matter facilitates the prediction of effect 3 110 in response to the occurrence of effect 1 104 and/or effect 2 106. The prediction of effect 3 110 may include the determination of correlations between the observed effects, such as effect 1 104 and effect 2 106, and previously observed effects. Such correlations may be referred to as lagged correlations.

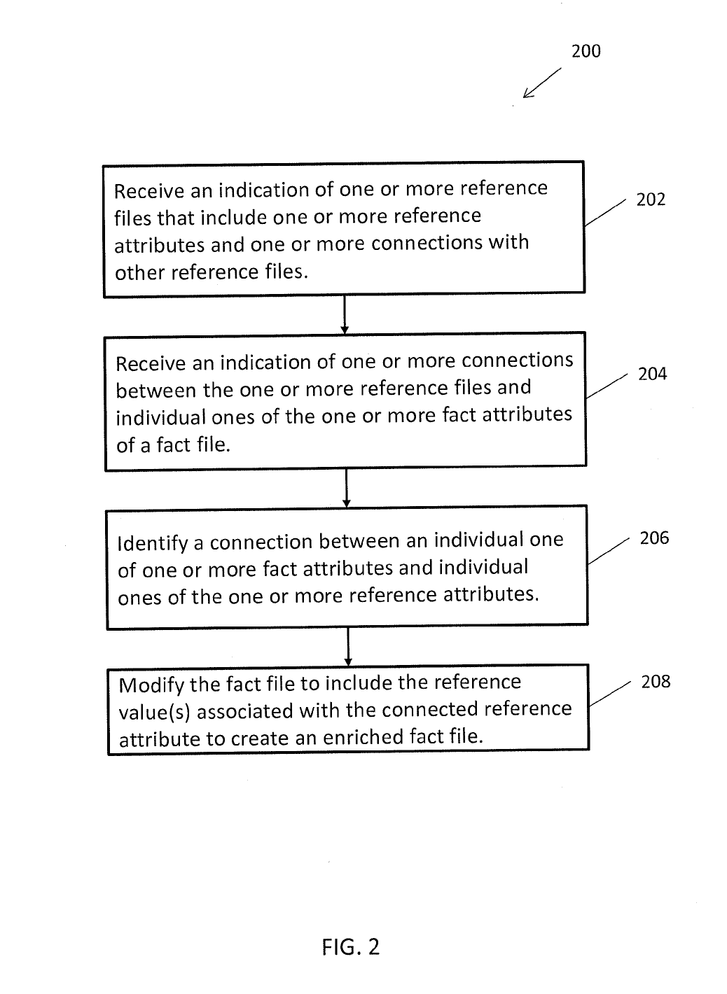

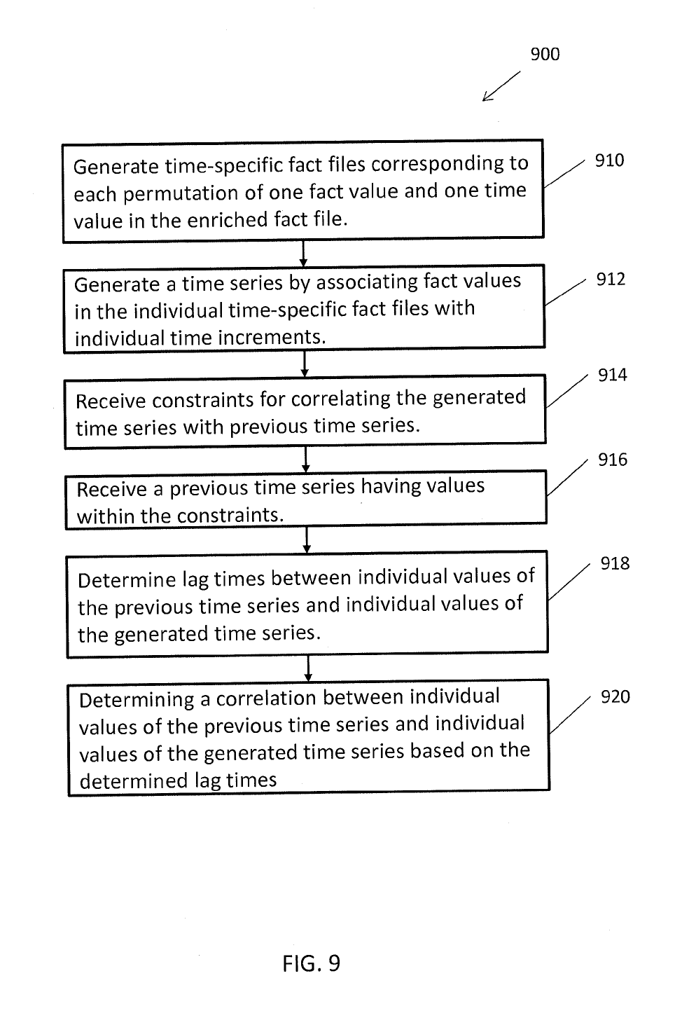

In one example of an implementation of the current subject matter, a dataset may include one or more data files, which may each include one or more values each of which has a value type. Value types may be characterized as an attribute, a fact, an indication of time, an identity, or other value-types. FIG. 2 and FIG. 9 show process flow charts 200, 900 illustrating features of methods consistent with some implementations described herein. It will be understood that the operations, processes, etc. depicted in FIG. 2 and FIG. 9 and described herein are illustrative. Certain ones of the operations may be omitted, exchanged for other operations, combined, or re-ordered.

Referring to FIG. 2, an indication of one or more reference files is received at 202. The one or more reference files may include one or more reference attributes. The one or more reference files may have one or more connections between other reference files of the one or more reference files.

At 204, an indication of one or more connections between the one or more reference files and individual ones of the one or more fact attributes of a fact file is received. In some variations, an indication of connections between reference attributes of different reference files may be received. For example, the one or more reference files may include a first reference file having a first attribute and a second reference file having a second reference attribute. A known connection between the first attribute and the second attribute may also be received. In some variations, the indication of the reference files may include receiving a name for the dataset, individual files names, file types, file format and structure, column names, column classification, and/or any file connections. File types may indicate whether a file is a fact file, a reference file, or another file type. File format and/or structure may indicate whether the file is a database file, a CSV file, a JSON file, an XML file, or another file format. Column classification may include an indication that an individual column includes attribute data, fact data, time data, identity data, and/or other data formats.

In response to receipt of one or more reference files and/or one or more connections between the one or more reference files, the computer program instructions, when executed by a computer processor, may cause the definition of all reference files and/or the connections between the reference files to be loaded into an electronic memory medium. Similarly, in response to receipt of an indication of a fact file, the definition of the fact file and any connections between the fact file and the reference files may be loaded into an electronic memory medium.

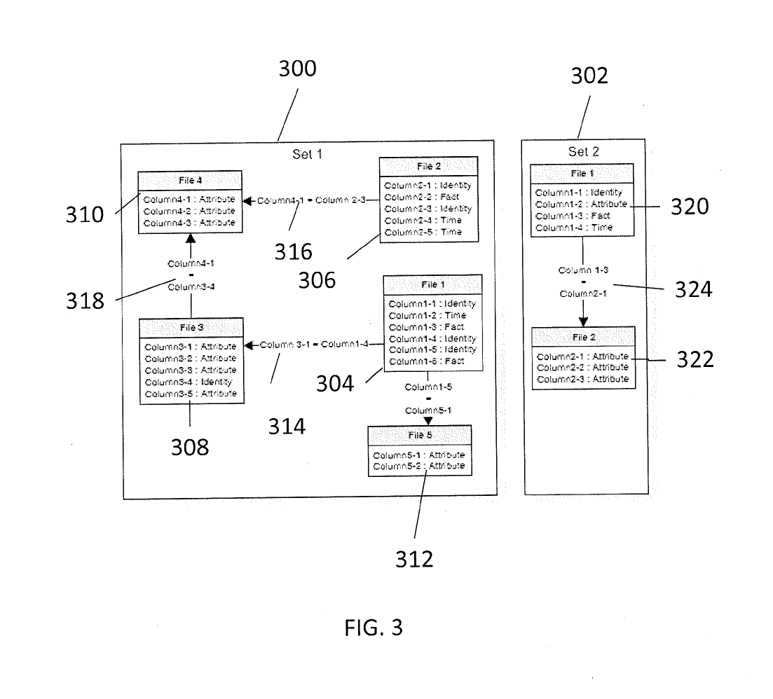

FIG. 3 is two conceptual illustrations of a first dataset 300 and a second dataset 302. The first dataset 300 may include a number of files. The files may be separated into two types. Files may be a fact-file-type or a reference-file-type. Fact-file-type files may include a fact. Reference-file-type files may not include a fact. For example, in the first dataset 300, file 1 304 and file 2 306 may be fact files. File 1 304 and file 2 306 each include at least one fact value. File 3 308, file 4 310, and file 5 312 may be reference-file-types. File 3 308, file 4 310, and file 5 312 do not include a fact value. Connections between the various files may exist. For example, a connection 314 may exist between file 1 304 and file 3 308. As illustrated, column 3-1 of reference file 308 is connected with column 1-4 of file 304. Such connections may be provided by a user. Connection 316 is a connection between fact file 2 306 and reference file 310. Connections may exist between the different reference files. For example, connection 318 illustrates a connection between column 4-1 of reference file 4 310 and column 304 of reference file 3 308.

The second dataset 302 includes fact file 1 320 and reference file 2 322. There is a connection 324 between fact file 1 320 and reference file 2 322. Connection 324 indicates a connection between column 1-3 of fact file 1 320 and column 2-1 of reference file 2 322.

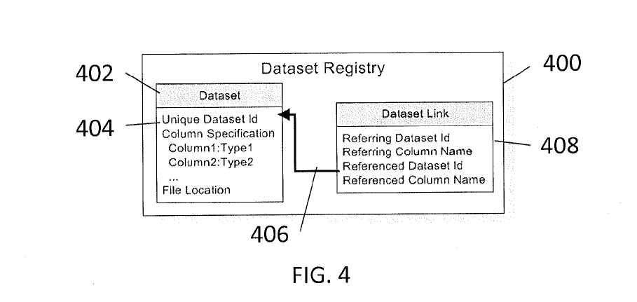

Referring to FIG. 4, execution of a computer program (e.g. one consisting of instructions to be executed by a computer processor) may cause a file registry 400 to be loaded into electronic memory media. The file registry 400 may include an identification 402 of each of the files. The identification may be unique to each of the files in the dataset and also unique to files in any dataset. For example, a unique identifier 404 for a file may include an identification of the data set as well as the identification of the file name. The file registry may include a specification of the columns within the files. For example, the column specification may include a list a list of column names and column pair values. The file registry may include the location of the files in the data set.

The file registry 400 may include an indication of a defined connection(s) 406 between each of the files in the file registry 400. The connection(s) 406 may have been provided to the computer program. The connection(s) 406 may have been provided by a user of the computer program. The connection(s) 406 may include an indication 408 of the values in other files in a dataset connected with individual ones of the other files in a dataset. As an example, the connection(s) 406 may include an indication 408 of the values of one or more of the reference files connected with values of a fact file.

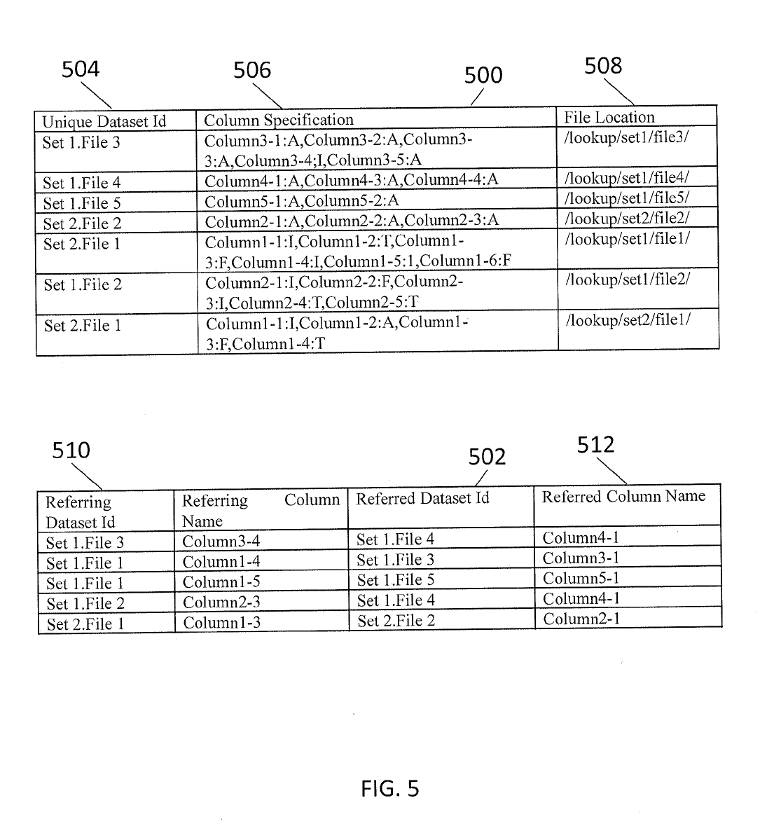

FIG. 5 conceptually shows the contents of the first dataset 500 and the second dataset 502 as loaded into a file registry. Unique Dataset Id 504 represents a unique identifier of the file in the file registry. Unique Dataset Id 504 is typically composed of the system name and the original file name. Column Specification 506 is a list of column name and column classification pair values. File Location 508 is the location where the data is physically stored. Referring Dataset Id 510 and Referring Column Name 512 represent the column that links to the Referenced Dataset Id 510 and Referenced Column Name 512. Although physically different, in practice the same column name may need to be present in both tables and, when the same value is present in both datasets, the referring dataset may be expanded with the columns in the referenced dataset.

The presently discloses computer program may logically process one fact file at a time. Multiple instances of the process disclosed herein may be executed in parallel. Each instance may logically process one fact file. Consequently, multiple fact files may be processed at the same time, in different instances.

Referring now to FIG. 2, at 206, a connection between fact attributes of a fact file and reference attributes of a reference file is identified. For example, a first connection may be identified between a first fact attribute and a first reference attribute.

The reference files and/or fact files may include columns Typically, a column is a set of data values of a particular type. The columns may provide the structure according to which the rows of a file are composed. The reference files and/or the fact files may have an attribute column, an amount column, a time column, an identity column, and/or other columns.

At 208, in response to identifying a connection between a fact attribute of the fact file and a reference attribute at 206, the fact file is modified to include one or more values of the reference file, creating an enriched fact file.

The file registry may include an identification of a referring dataset and a referring column name. The referring dataset identification and the referring column name represent the column that links to the referenced dataset and the referenced column name. When the same value is present in both datasets, the referring dataset may be expanded to include the columns in the referenced dataset. Subsequently, or concurrently, the values in the columns in the referenced dataset may be added to the new columns in the referring dataset.

The modified, or enriched, fact file may include additional values, or columns, from the reference files. The enriched fact file may be processed more than once consistent with the process of FIG. 2 as described above. The process may be repeated until no new connections between the fact file, or the enriched fact file, and the one or more reference exist. For example, in response to modifying the fact file with the reference values from the connected reference file, at 208, other connections may be identified between the modified fact file and other ones of the reference files. For individual ones of the one or more fact attributes, of the fact file, a second connection between a fact attribute of the fact file and a second reference attribute. In response to identifying the second connection, the enriched fact file may be modified to include one or more values of one or more of the reference files that correspond to the second reference attribute.

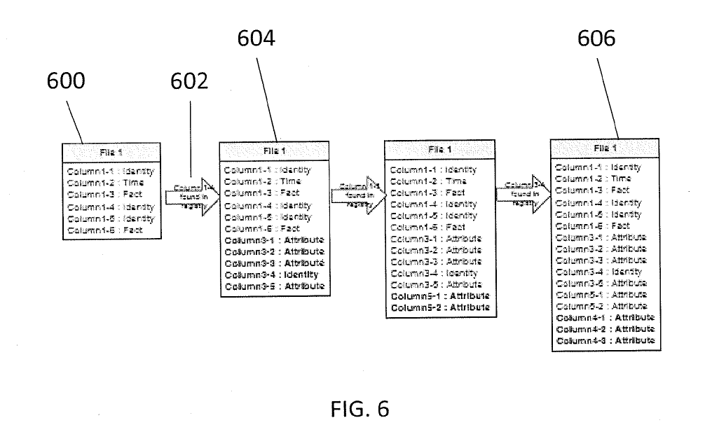

FIG. 6 shows a conceptual illustration of a fact file 600 being amended consistent with features of the process 200 illustrated in FIG. 2. A connection 602 between the fact file 600 and one or more reference files may be identified. The conceptual illustration of FIG. 6 shows that the connection 314 as shown in FIG. 3. The connection 314 being between column 4-1 of fact file 1 and column 3-1 of reference file 3. Fact file 600, as shown in FIG. 6, is modified to include the values of the reference file associated with the identified connection, to form an enriched fact file 604. The process is repeated until no new connections can be found between the consecutively enriched fact file and the one or more reference files. The process culminates in creating enriched fact file 606 that includes the reference values of all reference files for which a connection is identified with the fact file 600 and consecutively enriched fact files stemming from the fact file 500.

Similarly, the process of FIG. 2 may be repeated for all fact files in a dataset. The process of FIG. 2 may be repeated for each fact file in a separate instance of the computer program. In some variations, the values associated with identity may be discarded from the enriched fact files.

FIG. 7 shows a conceptual illustration of enriched fact files for each of the fact files and reference files conceptually illustrated in FIG. 3. The enriched fact files conceptually shown in FIG. 7 have been created through features consistent with the process in FIG. 2.

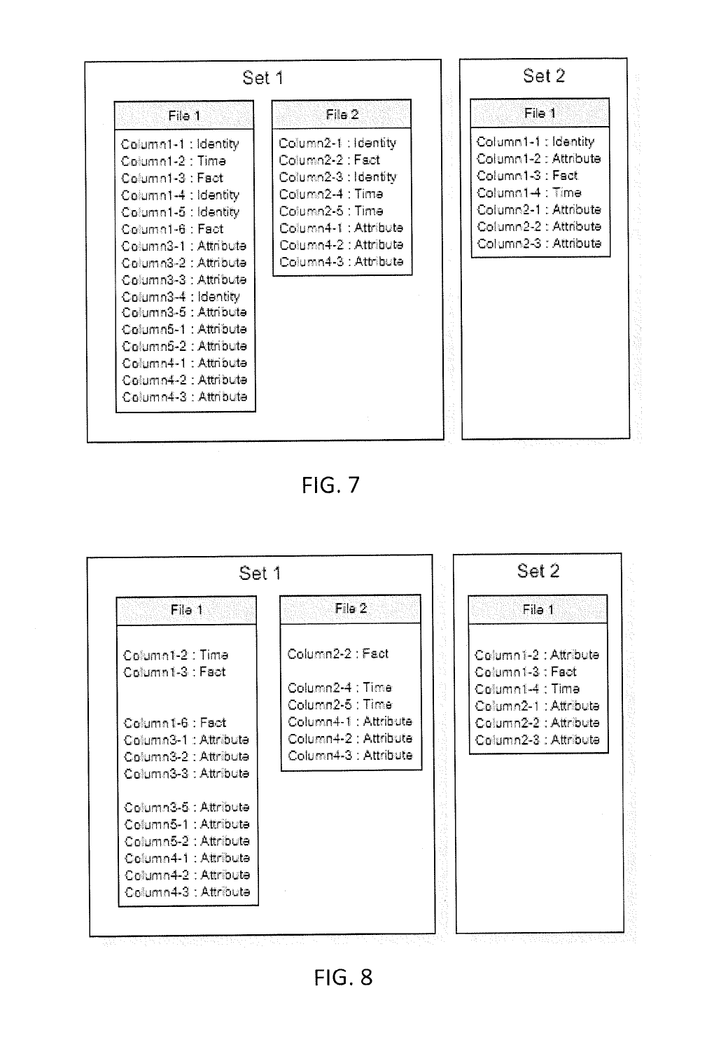

In some variations of the presently disclosed subject matter, the identity columns in the enriched fact files may be removed from the enriched fact files. FIG. 8 is a conceptual illustration of the enriched fact files conceptually illustrated in FIG. 7 having had their identity columns removed.

The process flow chart 900 of FIG. 9 includes additional method features relating to creating a time series associated with the enriched fact file. At 910, time-specific fact files are generated from an enriched fact file. The time-specific fact files may be generated for each permutation of fact value and time value. Attribute columns from the enriched fact file may be copied across the time-specific fact files generated from the enriched fact file. The time-specific fact files may include one or more of a fact attribute, a fact value associated with the fact attribute, and value, a time value corresponding to the fact attribute, and/or a reference value corresponding to the fact attribute.

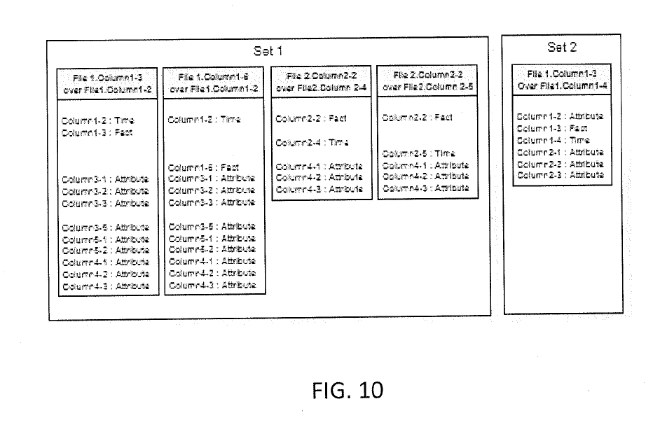

FIG. 10 conceptually illustrates each of the enriched fact files, as shown in FIG. 8, having been split for each permutation of one fact and one time value. File 1 of the first dataset, conceptually shown in FIG. 8, included one time value and two fact values. File 2 of the first dataset included two time values and one fact value. Consequently, after being split into all permutations of one fact value and one time value, the two enriched fact files of the first dataset will each be split into two time-specific fact files. The second dataset conceptually illustrated in FIG. 8 includes an enriched fact file containing only one time value and one fact value, and therefore is not split.

In some variations of the presently disclosed subject matter, the time-specific fact files may be further split for each of the attribute columns. The resulting number of files, should the time-specific fact files be further split for each of the attribute columns within each of the files, is governed by the following formula:

$${\sum }_{k = 0}^{n} \frac{n !}{( n - k ) ! k !} ,$$

where n is the number of attribute columns in each enriched file.

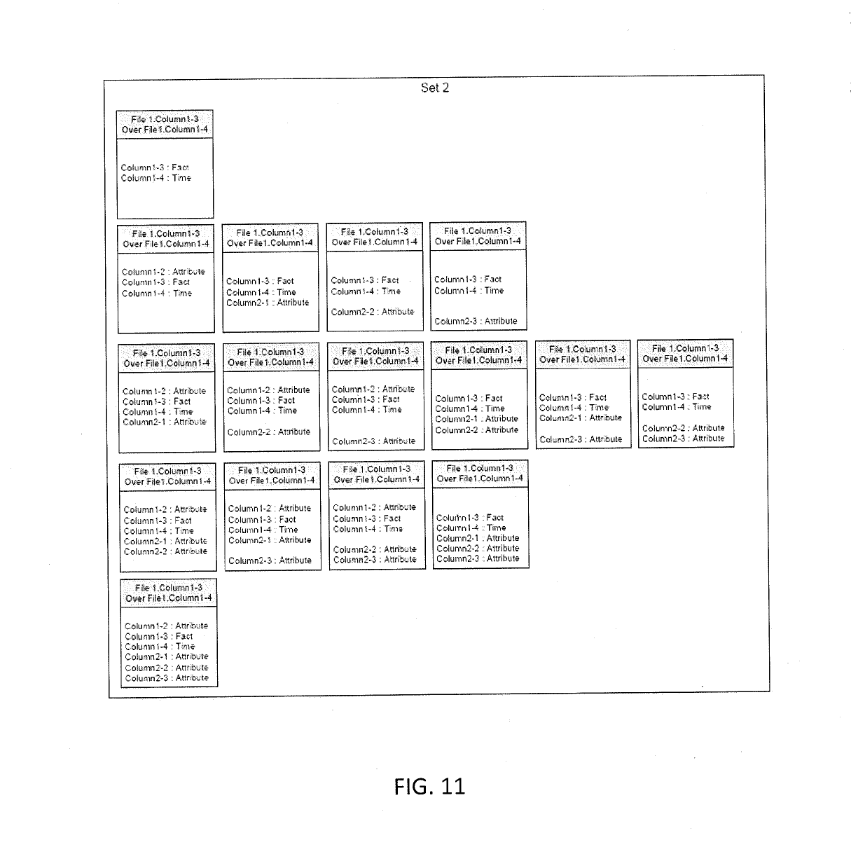

FIG. 11 illustrates the time-specific fact file of the second dataset as shown in FIG. 10 having been further split between each pair of one fact and one time value and all possible combinations for the set of attribute columns in the time-specific fact file of the second dataset. Even when there are only a few attribute values in an enriched fact file, the resultant number of files will be large. A maximum number of permutations may be provided by the computer program and/or a user of the compute program. The maximum number of permutations may limit the number of attribute columns which will be considered when splitting the time-specific fact files.

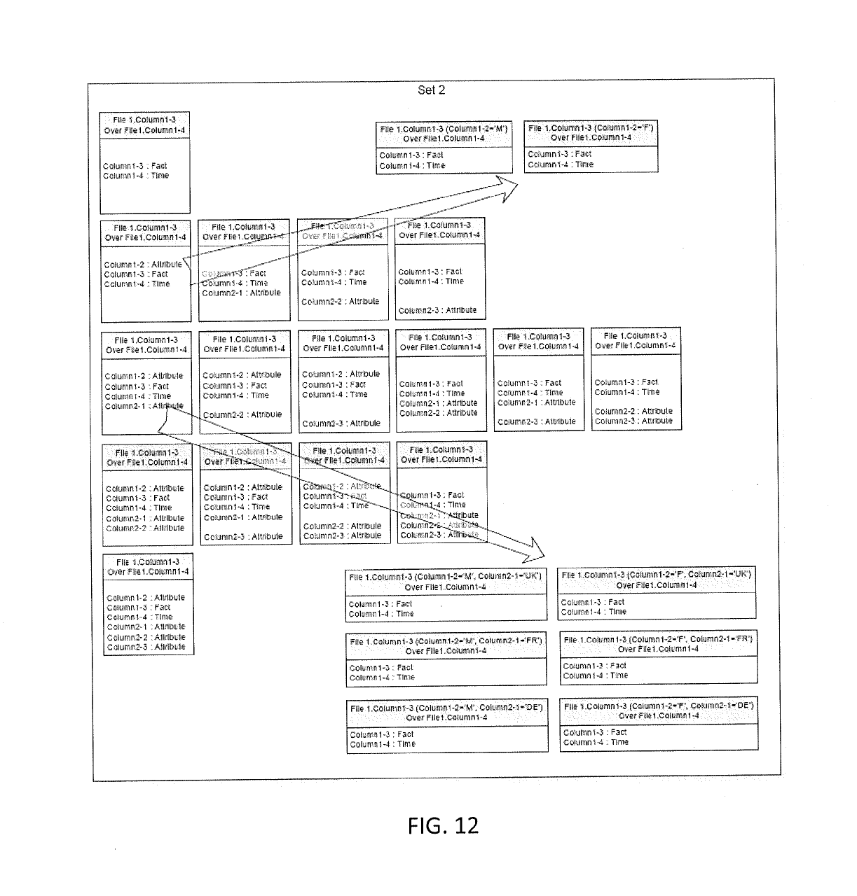

Each of the attribute columns may include multiple values. Each of the files illustrated in FIG. 11 may be further split for every permutation of value in each of the attribute columns. FIG. 12 conceptually illustrates two time-specific attribute-specific fact files of FIG. 11 being split into separate files for each attribute value. In some variations of the presently disclosed subject matter, attribute columns containing a large number of distinct values may be marked as identity columns. Consequently, those attribute columns may be removed from the fact files and/or reference files prior to processing them. Attribute columns having a large number of distinct values include gross salary. In some variations, an additional attribute column may be defined for such files that put the multiple distinct values into bands. For example, where the attribute column includes gross salary information, an additional attribute column may be defined to include gross salary bands. Consequently, the number of values in such an attribute column may be reduced.

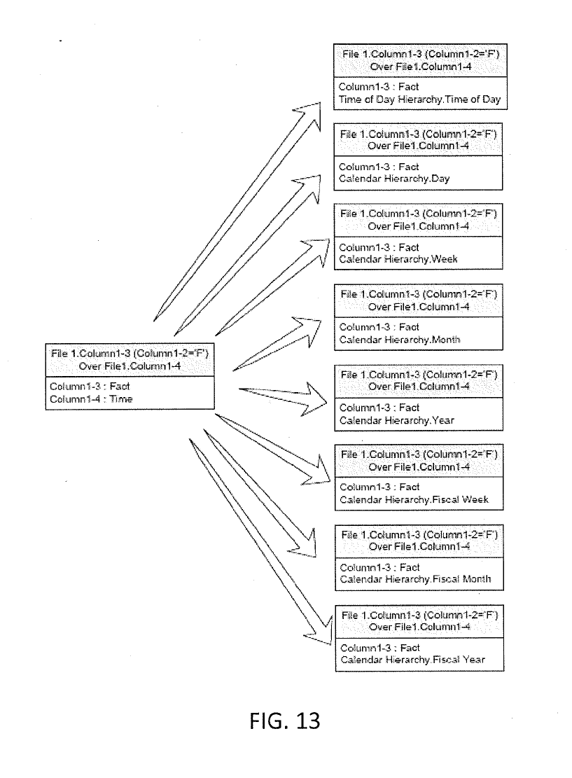

In some variations, the time values are expanded similarly to the attribute values. Each time value in the time column for each file is expanded to each level across a time hierarchy. In some variations, the time value may include a time range component and this too may be expanded. FIG. 13 conceptually illustrates a time value of one of the files conceptually illustrated in FIG. 12 expanded to each level across a time hierarchy. In the case shown, the time hierarchy includes time of day, day, week, month, year, fiscal week, fiscal month, and fiscal year. A time hierarchy may include any time increment as discussed below.

The process illustrated in FIG. 1 (and also occurring at 910 of FIG. 9) may produce a multitude of files. However, in individual ones of the files there may exist multiple values for the same time level, or increment, within the time hierarchy. For example, a travel ledger comprising thousands or millions of unique records will likely generate a file containing destinations by country for the day. Many passengers will travel to the same country on the same day. Therefore a file that contains destinations by country for the day will contain multiple distinct records, one for each passenger. The fact values for each of the files with the same time period can be aggregated.

Individual time-specific fact files that include time attributes associated with individual time increments are identified at 912. Time increments may include pre-defined increments of time. Time increments may include a set of predefined increments of time. For example, the time increments may include second, minute, hour, day, week, month, year, decade, century, millennium, and/or other time increments. In some examples, all of the time-specific fact files that fall within each time increment may be identified. The time-specific fact files that have a time value fall within an individual time increment may be grouped into the time increment.

Using the example discussed above with the travel ledger, after aggregation of the file containing country destinations by day will result in that file containing the number of people who traveled to a country on a particular day, rather than individual distinct value entries for each passenger.

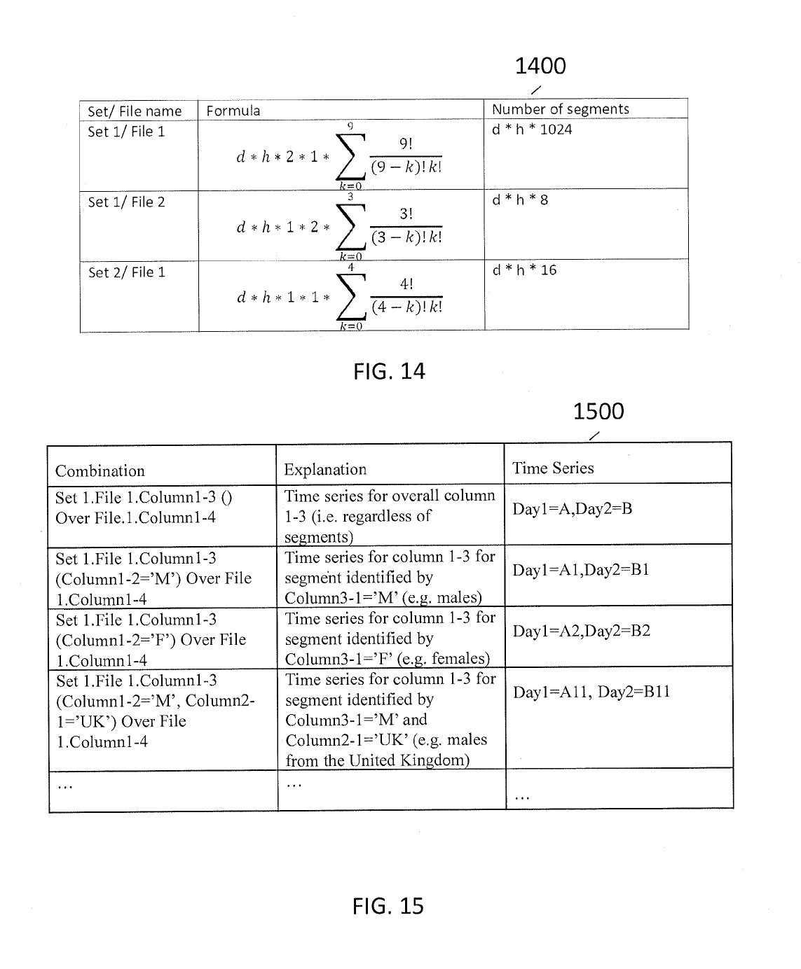

In some variations, aggregating the time data may occur prior to the other steps. Aggregating time data may affect the performance of the presently disclosed process(s). In some variations, aggregating the time data occurs prior to the results of the process(s) being written to a database.

Where files are created for permutation of fact and attribute across all levels of a time hierarchy, as conceptually illustrated in FIG. 13, the number of files is governed by the following formula:

$${\sum }_{k = 0}^{n} {}_{ }^{k}{C}{}_{n}^{ } = d * h * f * t * {\sum }_{k = 0}^{n} \frac{n !}{( n - k ) ! k !} ,$$

where d is a factor correlated with the number of distinct values across all combination of attributes, h is the number of levels in the time hierarchy, f is the number of fact columns, t is the number of time columns and n is the number of attribute columns. FIG. 14 shows a table 1400 illustrating the above formula applied to the three enriched fact files conceptually illustrated in FIG. 10. The table 1400 illustrated in FIG. 14 shows that even where there are a relatively small number of columns, the resultant number of files can be vast.

Where files, or segments, are too fine, or too insignificant comparative to an overall population, or if the files have too many dimensions, the files, or segments, may be marked as identity columns, and removed from consideration in the process. An upper restriction to the number of values in a segment may be set. In some variations, setting an upper restriction may cause the modification of the original fact and/or reference files such that they are amended to include a value range, instead of discrete values. In other variations, setting an upper restriction may cause aggregation of the files, or segments, during the process, into value ranges. Consequently, the group of attribute combinations (k), used in the above equation, can be enforced.

FIG. 15 conceptually illustrates a table 1500 having a list of values after aggregation of the time values in the example of the travel ledger discussed above. The example illustrated in FIG. 15 also has the following constraints: column 3-1 has only two values (Males, Females); and, column 2-1 represents a list of country codes. The following equations would hold true for the Time Series of the table illustrated in FIG. 15:

A=A1+A2 and B=B1+B2

A11≦A1≦A and B11≦B1≦B

The table illustrated in FIG. 15 uses the following naming conventions:
Set 1.File 1.Column1-3—uniquely identifies the value for which a time series is created in the set/file and column. This will only be created for columns of type amount (facts).
( )—specifies any segments (i.e. filters) for which the series is built. Any number of filters are allowed for this clause, but in some variations only on columns of type attribute (dimensions).
Over File1.Column1-4—specifies the date column which creates the time series. This is only valid for columns originally defined as time.

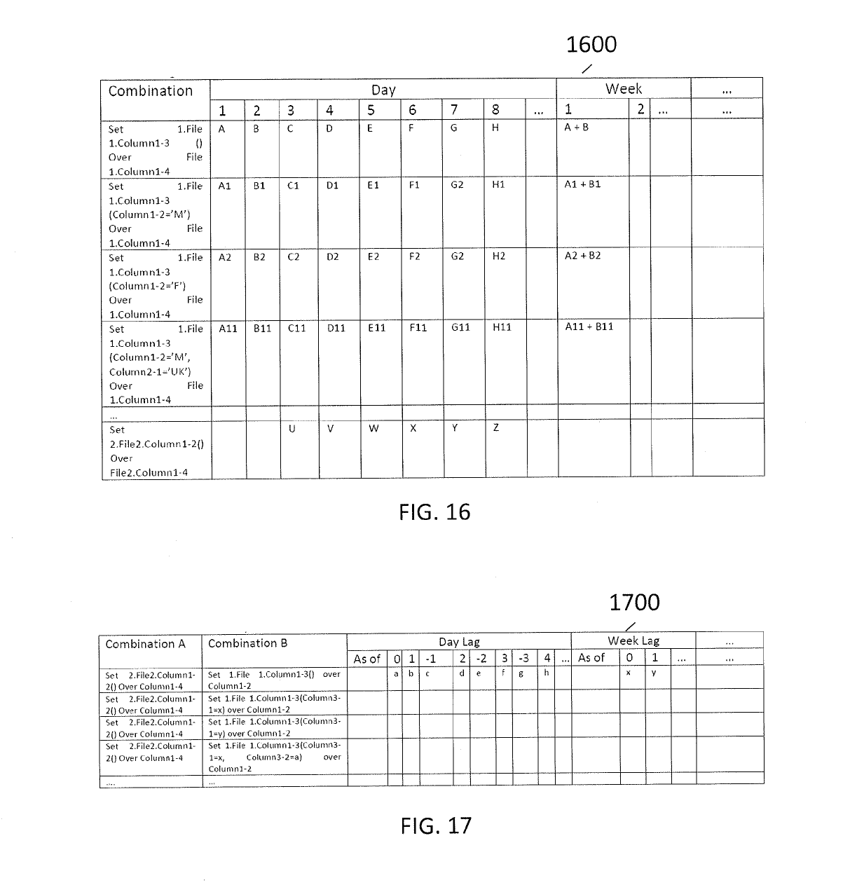

FIG. 16 conceptually illustrates a sparse matrix 1600 in a large column database, into which, the segments, or files, resulting from the Time Series conceptually illustrated in FIG. 15 is written.

Distance correlations may be calculated for seemingly independent time series. Seemingly independent time series are series for different amounts or for the same amount but for distinct and mutually exclusive segments. As an example, correlations may be determined between the amount of sales and changes to the house prices index or the amount of sales for beer products and the amount of sales for nappy products).

Referring to FIG. 9, at 914, constraints are received for correlating the generated time series with previous time series. The constraints may include limits on one or more parameters of previous time series that dictate which of the previous time series can be used for determining correlations between fact values in the generated time series and fact values in the previous time series. The one or more parameters, for which the constraints may provide limits, may include, but not be limited to, a maximum age of fact values in previous time series that can be used to determine correlations between fact values in the generated time series and fact values in previous time series. As an example, for certain applications it may be inappropriate to correlate daily observations of facts that occurred ten years ago with present day daily observations. Depending on the application, daily observations occurring ten years ago may not have any bearing on the daily observations measured in the present. Consequently, the constraints applied to a generated time series that include present day daily observations may exclude daily observations that occurred ten years ago.

The parameters may include a lag amount indicating an acceptable lag between previous correlations. The parameters may include a number of observations in a particular time interval. The constraints may provide a minimum number of observations that can be used in the correlations between the generated time series and the previous time series. The minimum number of observations may apply to either the previous time series, the generated time series, or both time series. Where a time increment in a generated time series or a previous time series has less than the minimum number of observations, a longer time increment may be used where there are sufficient observations.

At 916, previous time series conforming with the constraints are received. For example, the previous time series that are received may have fact values within a maximum age provided by the constraints for the attributes of the generated time series may be received. In some variations, the previous time series may be accessed by the computer processor.

Lag times between individual attributes of the previous time series and individual attributes of the generated time series may be determined at 918, and a correlation between individual attributes of the previous time series and individual attributes of the generated time series may be determined based on the determined lag times at 920.

In some variations, the smallest number (n) of recent observations between a first time series (X) and a second time series (Y) that conform with the constraints may be used. Centered square matrices A and B, for series X and Y, respectively, may be created. The matrices may include the distances between each element in the series and may conform to the following:

a_{j,k}=abs(Xⱼ−Xₖ), b_{j,k}=abs(Yⱼ−Yₖ) for j,k= 1̅,̅n̅

A doubly centered matrix, A′ and B′ may be created for matrix A and B, conforming to the following:

a′_{j,k}=a_{j,k}− a̅ⱼ̅− a̅ₖ̅+ā, b′_{j,k}=b_{j,k}− b̅ⱼ̅− b̅ₖ̅+ b̅ for j,k= 1̅,̅n̅ where

a̅ⱼ̅ is the mean for row j of matrix A, b̅ⱼ̅ is the mean for row j of matrix B;
a̅ₖ̅ is the mean for column k of matrix A, b̅ₖ̅ is the mean for column k of matrix B;
ā is the overall mean of matrix A, b̅ is the overall mean for matrix B.

The distance covariance of X and Y, the distance variance of X and the distance variance of Y is calculated:

$$d Cov ( X , Y ) = \sqrt{\frac{{\sum }_{i , j = \overline{1 , n}} {a}_{i , j}^{′} {b}_{i , j}^{′}}{{n}^{2}}} , d Var ( X ) = \sqrt{\frac{{\sum }_{i , j = \overline{1 , n}} {a}_{i , j}^{′} {b}_{i , j}^{′}}{{n}^{2}}} , d Var ( Y ) = \sqrt{\frac{{\sum }_{i , j = \overline{1 , n}} {a}_{i , j}^{′} {b}_{i , j}^{′}}{{n}^{2}}}$$

The distance correlation of X and Y may be calculated:

$$d Cor ( X , Y ) = \frac{d Cov ( X , Y )}{\sqrt{d Var ( X ) * d Var ( Y )}}$$

The distance correlations may be stored when calculated and exploited to determine the lag correlations between the seemingly independent time series. FIG. 17 shows a table 1700 conceptually illustrating exploitation of the distance correlations calculated using the above formula. The “As if” columns represent the latest calculation date for each time increment of the time series. All correlation values (a, b, c, etc.) are between −1 and 1.

Some specific use cases of the presently disclosed process may include use by an insurance company to establish models to calculate appropriate premiums for each customer. The insurance company would typically possess information on their customers. Such information may include gender, age, declared event history, turnover, and/or other information. The insurance company may obtain a new set of data. Such data may come from any number of sources. For example, the data may include data from another company, data from the government, weather data, search engine trend data, and/or other data. The presently disclosed computer program may facilitate a determination of whether the new dataset, or any part thereof, may correlate with the insurance company's existing data. This may lead to a determination as to whether any of the new datasets can be incorporated into the premiums calculation model to further improve the accuracy of the premiums.

The ability to determine correlations between seemingly disparate datasets, as provided by the presently disclosed subject matter, may compensate for regulatory requirements that decrease the accuracy of an insurance company's premiums by ruling out some attributes (e.g. the gender of the insurer) from the premium calculation engine.

As another specific use case, a payment industry company may handle transactions for a vast number of merchants. Although the company may possess information on the transaction it may not have detailed data on the merchants or their customers. The payment industry company may exploit other data to find correlations. Such other data may include public data. The public data may have been made available from the government. As an example, a correlation may be determined, using the presently disclosed computer program, between the number of apartments sold in a particular area, and the amount spent with middle-tier furniture stores in and surrounding the area. The presently disclosed computer program may be used to identify that the correlations between the number of apartments sold in a particular area, and the amount spent with middle-tier furniture stores in and surrounding the area lags by four months. The company may then be in a position to advise merchants on where and when to open new stores.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a non-transitory machine-readable medium storing instructions that, when executed by at least one programmable processor, cause the at least one programmable processor to perform operations comprising:
receiving an indication of one or more reference files that include one or more reference attributes and one or more values associated with individual ones of the reference attributes and which have one or more connections between other reference files of the one or more reference files;
receiving an indication of one or more connections between the one or more reference files and individual ones of one or more fact attributes of a fact file, the fact file including one or more fact attributes, fact values associated with the fact attributes and time values associated with the fact attributes;
identifying, for individual ones of the one or more fact attributes, a connection between an individual one of the one or more fact attributes and individual ones of the one or more reference attributes, such that a first connection is identified between a first fact attribute and a first reference attribute; and,
modifying, in response to identifying the first connection, the fact file to include the one or more reference values associated with the first reference attribute to create an enriched fact file.

2. The computer program product as in claim 1, wherein the instructions, when executed by at least one programmable processor, cause the at least one programmable processor to perform further operations comprising:
identifying, responsive to modifying the fact file, for individual ones of the one or more fact attributes, a second connection between the first fact attribute and a second reference attribute; and,
modifying, in response to identifying the second connection, the fact file to include the one or more reference values associated with the second reference attribute.

3. The computer program product as in claim 1, wherein the instructions, when executed by at least one programmable processor, cause the at least one programmable processor to perform further operations comprising:
generating time-specific fact files corresponding to each permutation of a single fact attribute and a single time value in the enriched fact file, where individual ones of the time-specific fact files include a fact attribute and associated fact value and a time value corresponding to the fact attribute.

4. The computer program product as in claim 3, wherein the instructions, when executed by at least one programmable processor, cause the at least one programmable processor to perform further operations comprising:
identifying individual time-specific fact files that include time values associated with individual time increments; and,
generating a time series by associating fact attributes in the individual time-specific fact files with individual ones of the time increments, based on the identified time values associated with the individual time increments.

5. The computer program product as in claim 4, wherein the instructions, when executed by at least one programmable processor, cause the at least one programmable processor to perform further operations comprising:
receiving constraints for correlating the generated time series with previous time series, the constraints including limits on one or more parameters of previous time series that dictate which of the previous time series can be used for determining correlations between fact values in the generated time series and fact values in previous time series;
receiving a previous time series having fact values falling within one or more limits of the constraints;
determining lag times between individual attributes of the previous time series and individual attributes of the generated time series; and,
determining a correlation between individual fact values of the previous time series and individual fact values of the generated time series based on the determined lag times.

6. The computer program product as in claim 5, wherein the one or more parameters of the previous time series includes an age of the fact values and the constraints for correlating the generated time series with previous time series include a maximum age.

7. The computer program product as in claim 5, wherein the one or more parameters of the previous time series includes an amount of fact values corresponding to individual time increments and the constraints for correlating the generated time series with previous time series include a minimum amount of fact values associated with individual time increments.

8. The computer program product as in claim 5, wherein the one or more parameters of the previous time series includes a lag amount between previous correlations and the constraints for correlating the generated time series with previous time series include a maximum lag amount.

9. The computer program product as in claim 3, wherein the instructions, when executed by at least one programmable processor, cause the at least one programmable processor to perform further operations comprising:
generating time-specific attribute-specific fact files corresponding to each permutation of a single fact attribute, a single time value, and a single reference attribute in the enriched fact file.

10. The computer program product as in claim 9, wherein the instructions, when executed by at least one programmable processor, cause the at least one programmable processor to perform further operations comprising:
generating value-specific fact files corresponding to each permutation of fact and time pairs of the enriched fact file and individual reference value of the reference values in at least one of the reference attributes.

11. A system comprising:
computer hardware configured to perform operations comprising:
receiving an indication of one or more reference files that include one or more reference attributes and one or more values associated with individual ones of the reference attributes and which have one or more connections between other reference files of the one or more reference files;
receiving an indication of one or more connections between the one or more reference files and individual ones of one or more fact attributes of a fact file, the fact file including one or more fact attributes, fact values associated with the fact attributes and time values associated with the fact attributes;
identifying, for individual ones of the one or more fact attributes, a connection between an individual one of the one or more fact attributes and individual ones of the one or more reference attributes, such that a first connection is identified between a first fact attribute and a first reference attribute; and,
modifying, in response to identifying the first connection, the fact file to include the one or more reference values associated with the first reference attribute to create an enriched fact file.

12. The system as in claim 11 wherein the computer hardware is further configured to perform operations comprising:
identifying, responsive to modifying the fact file, for individual ones of the one or more fact attributes, a second connection between the first fact attribute and a second reference attribute; and,
modifying, in response to identifying the second connection, the fact file to include the one or more reference values associated with the second reference attribute.

13. The system as in claim 11 wherein the computer hardware is further configured to perform operations comprising:
generating time-specific fact files corresponding to each permutation of a single fact attribute and a single time value in the enriched fact file, where individual ones of the time-specific fact files include a fact attribute and associated fact value and a time value corresponding to the fact attribute.

14. The system as in claim 13 wherein the computer hardware is further configured to perform operations comprising:
identifying individual time-specific fact files that include time values associated with individual time increments; and,
generating a time series by associating fact attributes in the individual time-specific fact files with individual ones of the time increments, based on the identified time values associated with the individual time increments.

15. The system as in claim 14 wherein the computer hardware is further configured to perform operations comprising:
receiving constraints for correlating the generated time series with previous time series, the constraints including limits on one or more parameters of previous time series that dictate which of the previous time series can be used for determining correlations between fact values in the generated time series and fact values in previous time series;
receiving a previous time series having fact values falling within one or more limits of the constraints;
determining lag times between individual attributes of the previous time series and individual attributes of the generated time series; and,
determining a correlation between individual fact values of the previous time series and individual fact values of the generated time series based on the determined lag times.

16. The system as in claim 15, wherein the one or more parameters of the previous time series includes an age of the fact values and the constraints for correlating the generated time series with previous time series include a maximum age.

17. The system as in claim 15, wherein the one or more parameters of the previous time series includes an amount of fact values corresponding to individual time increments and the constraints for correlating the generated time series with previous time series include a minimum amount of fact values associated with individual time increments.

18. The system as in claim 15, wherein the one or more parameters of the previous time series includes a lag amount between previous correlations and the constraints for correlating the generated time series with previous time series include a maximum lag amount.

19. The system as in claim 13, wherein the computer hardware is further configured to perform operations comprising:
generating time-specific attribute-specific fact files corresponding to each permutation of a single fact attribute, a single time value, and a single reference attribute in the enriched fact file.

20. The system as in claim 19, wherein the computer hardware is further configured to perform operations comprising:
generating value-specific fact files corresponding to each permutation of fact and time pairs of the enriched fact file and individual reference value of the reference values in at least one of the reference attributes.

21. A computer-implemented method comprising:
receiving an indication of one or more reference files that include one or more reference attributes and one or more values associated with individual ones of the reference attributes and which have one or more connections between other reference files of the one or more reference files;
receiving an indication of one or more connections between the one or more reference files and individual ones of one or more fact attributes of a fact file, the fact file including one or more fact attributes, fact values associated with the fact attributes and time values associated with the fact attributes;
identifying, for individual ones of the one or more fact attributes, a connection between an individual one of the one or more fact attributes and individual ones of the one or more reference attributes, such that a first connection is identified between a first fact attribute and a first reference attribute; and,
modifying, in response to identifying the first connection, the fact file to include the one or more reference values associated with the first reference attribute to create an enriched fact file.
